(19) United States
(12) Patent Application Publication
(10) Pub. No.: US 2011/0275760 A1
(43) Pub. Date: Nov. 10, 2011

(54) MODIFIED POLYAMIDES HAVING ENHANCED MELT FLOW INDICES

(76) Inventors: Lise Trouillet-Fonti, Villette-de-Vienne (FR); Marco Amici, Paruzzaro (No) (IT); Jean-Francois Thierry, Francheville (FR)

(21) Appl. No.: 12/680,245

(22) PCT Filed: Sep. 29, 2008
(86) PCT No.: PCT/EP2008/063002

§ 371 Date: Jul. 28, 2011

(30) Foreign Application Priority Data
Sep. 28, 2007 (FR) 0706820

(51) Int. Cl. C08L 77/06; B29C 49/00; C08K 7/14; C08G 69/26; C08G 69/30

(52) U.S. Cl. 524/607; 528/340; 528/342; 264/500

(57) ABSTRACT

Novel modified polyamides are prepared by polymerization of diacid and diamine monomers in the presence of certain multifunctional and, optionally, monofunctional compounds; such novel polyamides are formulated into molding compositions which can be converted into useful shaped articles.

The present invention relates to a polyamide, to a process for manufacturing it and to compositions containing it. The invention more particularly concerns a polyamide obtained by polymerization of diacid and diamine monomers in the presence of multifunctional and optionally monofunctional compounds. This polyamide is especially useful for the manufacture of compositions that are intended, for example, to be molded.

Polyamide-based thermoplastic compositions are raw materials that can be transformed by molding, especially by injection molding, to manufacture plastic components.

There are at least three major properties that it is desired to obtain for these polyamide-based compositions, especially when they are used in these transformation processes.

The first of these properties lies in the fact that these thermoplastic compositions used must be characterized, in the melt state, by a flow index or rheological behavior that are compatible with certain forming processes, such as injection molding. Specifically, these thermoplastic compositions must be sufficiently fluid when they are molten, so as to be able to be conveyed and handled easily and quickly in certain forming devices, for instance injection molding devices.

It is also sought to increase the mechanical properties of these compositions. These mechanical properties are especially the impact strength, the flexural or tensile modulus, and the flexural or tensile breaking stress, inter alia. Reinforcing fillers such as glass fibers are generally used for this purpose.

Finally, in the case of components molded from these thermoplastic compositions, a clean and uniform surface aspect is sought. This constraint becomes a difficult problem to solve particularly when use is made of a thermoplastic composition highly charged with glass fibers, since these glass fibers impair the surface aspect of the molded components. To obtain an acceptable surface aspect, it is known practice to use thermoplastic compositions with a high flow index. However, this increase in fluidity results in a decrease in the mechanical properties of the articles obtained.

As a result, it is thus difficult to obtain these various properties for the same polyamide-based thermoplastic composition.

The Applicant has developed a polyamide modified with multifunctional and optionally difunctional and/or monofunctional compounds that has an increased flow index and mechanical properties that are equivalent or superior to those of standard linear polyamides, and which allows the preparation of articles having an excellent surface aspect, especially when they contain a large amount of fillers.

Such a polyamide is obtained by polymerization of dicarboxylic acid and diamine monomers, of a monofunctional compound containing at least three acid or amine functions capable of forming an amide bond with the functions of said dicarboxylic and diamine monomers, and optionally of difunctional and/or monofunctional compounds containing acid or amine functions, which are capable of forming an amide function with the functions of said dicarboxylic acid and diamine monomers. The polymerization process is conventional and corresponds to that usually used for the polymerization of polyamide based on diacid and diamine monomers, such as polyamide 66.

A first subject of the present invention is thus a polyamide obtained by polymerization in the presence of at least:
dicarboxylic acid monomers of the type AA and diamine monomers of the type BB, or salts thereof;
a multifunctional compound (i) comprising either at least 3 functions A or at least 3 functions B;
optionally a monofunctional compound (ii) comprising either a function A or a function B;
   the functions A and B being functions that are capable of reacting together to form an amide bond; said polyamide comprising:
from 0.02 mol % to 0.6 mol %, relative to the number of moles of constituent monomers of the polyamide, of a unit corresponding to the multifunctional compound (i);
optionally from 0 to 2 mol %, relative to the number of moles of constituent monomers of polyamide, of a unit corresponding to the monofunctional compound (ii);
   the polyamide obtained having a difference in absolute value ΔGT between its end groups that is greater than or equal to the value Q (limit ΔGT); this value Q being defined by:

Q=α.[(β−Tᵢᵢ)²−γ]^{0.5},

if the amount between the square brackets (β−Tᵢᵢ)²−γ is positive; or

Q=0,

if the amount between the square brackets (β−Tᵢᵢ)²−γ is negative or zero;
with:
α=72
β=0.625.(f−2)³.Tᵢ²+(f−2).Tᵢ+2
γ=2.6
Tᵢ corresponds to the molar percentage of multifunctional compound (i)
Tᵢᵢ corresponds to the molar percentage of multifunctional compound (ii)
f corresponds to the functionality of the multifunctional compound (i) and thus corresponds to the number of functions A or B borne by the multifunctional compound (i); and
the amounts ΔGT and Q being expressed in meq/kg.

It is clearly understood that the difference between the end groups ΔGT should be taken as its absolute value, i.e. always positive.

The functions A and B are functions that are capable of reacting together to form an amide bond. Function A may be a dicarboxylic acid function or a salt thereof or alternatively a precursor function of function A capable of generating a function A in the polymerization medium. Mention may be made especially of nitrile, primary amide, anhydride and ester functions. Function B may be a primary or secondary amine function or a salt thereof or alternatively a precursor function of function B that is capable of generating a function B in the polymerization medium. Mention may be made especially of isocyanate and carbamate functions.

For example, in the particular cases in which the multifunctional compound (i) is trifunctional (f=3) or tetrafunctional (f=4), respectively, this gives:

β=0.625.Tᵢ²+Tᵢ+2 for f=3

and β=5.Tᵢ²+2.Tᵢ+2 for f=4, respectively.

Preferentially, the values for β may be:
α=85,
β=0.46.(f−2)³.Tᵢ²+1.15.(f−2).Tᵢ+2.1, and
γ=2.14.

Preferentially, for the trifunctional (f=3) or tetrafunctional (f=4) multifunctional compounds, this may give:

β=0.46.Tᵢ²+1.15.Tᵢ+2.1 for f=3

and β=3.68.Tᵢ²+2.3.Tᵢ+2.1 for f=4, respectively.

It is thus seen that, according to the invention, the modified polyamide obtained has a ΔGT value that should be greater than or equal to, as an absolute value, the value Q, taking into account the content of multifunctional compound (i) and optionally the content of multifunctional compound (ii). To obtain a ΔGT that is greater than or equal to said value Q, a person skilled in the art is entirely capable of adding to the polymerization compounds, especially dicarboxylic acid or diamine monomers, if necessary. Needless to say, depending on the polymerization processes used and the loss of volatile monomers resulting therefrom, a person skilled in the art knowing his installation will be capable of making the necessary corrections as regards the proportions of monomers and compounds (i) and (ii) introduced so as to obtain the desired ΔGT.

The difference between the end groups ΔGT may especially be calculated by adding the ΔGT induced by the addition of compounds (i) and (ii), the ΔGT induced by the addition of excess monomers of diacid or diamine type, and the ΔGT calculated or measured by the loss of volatile compounds in the polymerization process.

It is entirely possible to add, for example in polymerization, an equimolar amount of dicarboxylic acid and diamine, and a certain proportion of dicarboxylic acid or diamine, of identical or different nature.

The term “number of moles of constituent monomers of the polyamide” means the total number of moles of monomer units and of units corresponding to the other constituents of said polyamide, i.e. the number of moles of dicarboxylic acid units added to the number of moles of diamine units, the number of moles of compounds (i) and optionally the number of moles of compounds (ii), to which is optionally added the number of moles of amino acids or lactams. The molar percentage of a compound corresponds to the number of moles of this compound relative to the number of moles of constituent monomers of the polyamide.

The multifunctional (i) and monofunctional (ii) compounds may thus bear functions A or B, of the same nature; either of carboxylic acid type or precursor of a carboxylic acid function, or of amine type or precursor of an amine function; or alternatively functions A and B of different nature.

Preferentially, when the multifunctional compound (i) bears functions of the type A, the monofunctional compound (ii) then bears a function of the type B; similarly, when the multifunctional compound (i) bears functions of the type B, the monofunctional compound (ii) then bears a function of the type A.

Preferentially, the polyamide according to the invention is obtained by polymerization of the dicarboxylic acid and diamine monomers, or salts thereof, only one type of multifunctional compound (i) and only one type of monofunctional compound (ii).

However, it is also possible for the polymerization to be performed with a mixture of different multifunctional compounds (i), especially bearing either functions A or functions B; for instance a mixture of 2,2,6,6-tetrakis(β-carboxyethyl)cyclohexanone and trimesic acid.

In this case, it is preferred to modify the amount β of the expression Q in the following manner:

β=2+Σₖ[0.625(fₖ−2)³Tᵢₖ²+(fₖ−2)Tᵢₖ]

in which k represents the index of each multifunctional compound used, the compound k having the functionality fₖ and being added in a molar percentage Tᵢₖ.

Preferentially, the amount β of the expression Q is equal to:

β=2.1+Σₖ[0.46.(fₖ−2)³Tᵢₖ²1.15.(fₖ−2)Tᵢₖ]

The dicarboxylic acid and diamine monomers are especially those conventionally used for the manufacture:
of aliphatic polyamides, of the type PA 6.6, PA 6.10, PA 6.12, PA 12.12 and PA 4.6,
of semiaromatic polyamides, such as poly(m-xylylenediamine adipate) (MXD6), polyterephthalamides, such as polyamides 6.T and 6.6.6T, and polyisophthalamides, such as polyamides 6.I and 6.6.6I,
polyaramids,
or copolymers thereof.

These dicarboxylic acid and/or diamine monomers may be aliphatic, especially with a linear, branched or cyclic chain, or aromatic.

Dicarboxylic acid monomers that may especially be mentioned include aliphatic or aromatic dicarboxylic acids containing from 4 to 12 carbon atoms, such as adipic acid, terephthalic acid, isophthalic acid, pimelic acid, suberic acid, decanedioic acid and dodecanedioic acid.

Diamine monomers that may especially be mentioned include aliphatic, optionally cycloaliphatic, or aromatic diamines containing from 4 to 12 carbon atoms, such as hexamethylenediamine, butanediamine, m-xylylenediamine, isophoronediamine, 3,3′,5-trimethylhexamethylenediamine and methylpentamethylenediamine.

The monomers may optionally be combined in the form of salts of the dicarboxylic acid and diamine monomers.

It is especially preferred according to the present invention to use the constituent monomers of polyamide 66, which are adipic acid and hexamethylenediamine, or the salt thereof, such as hexamethylenediammonium adipate, also known as Nylon salt or N salt.

The modified polyamide according to the invention may comprise one or more dicarboxylic acids and one or more diamines, of various types.

Amino acids or lactams thereof, for instance caprolactam, may also be added to the dicarboxylic acid and diamine monomers. From 1 mol % to 15 mol % and preferentially from 2 mol % to 10 mol % of amino acids or lactams relative to the number of moles of constituent monomers of the polyamide may especially be added to the reaction medium.

The multifunctional compound (i) according to the invention comprises at least 3, preferentially between 3 and 8 and more preferentially 3 or 4 functions A or B.

The multifunctional compound (i) is generally an aliphatic, cycloaliphatic and/or aromatic hydrocarbon-based compound containing from 1 to 100 carbon atoms and possibly comprising one or more heteroatoms. The heteroatoms may be O, S, N or P.

The multifunctional compound (i) may especially comprise a cyclohexyl, a cyclohexanoyl, a benzyl, a naphthyl, an anthracenyl, a biphenyl, a triphenyl, a pyridine, a bipyridine, a pyrrole, an indole, a furan, a thiophene, a purine, a quinoline, a phenanthrene, a porphyrin, a phthalocyanin, a naphthalocyanin, a 1,3,5-triazine, a 1,4-diazine, a 2,3,5,6-tetraethylpiperazine, a piperazine and/or a tetrathiafulvalene.

As multifunctional compounds (i) bearing carboxylic acid functions, mention may be made especially of 2,2,6,6-tetrakis(β-carboxyethyl)cyclohexanone, diaminopropane-N,N,N′, N′-tetraacetic acid, 3,5,3′,5′-biphenyltetracarboxylic acid, acids derived from phthalocyanin and naphthalocyanin, 3,5,3′,5′-biphenyltetracarboxylic acid, 1,3,5,7-naphthalenetetracarboxylic acid, 2,4,6-pyridinetricarboxylic acid, 3,5,3′,5′-bipyridyltetracarboxylic acid, 3,5,3′,5′-benzophenonetetracarboxylic acid, 1,3,6,8-acridinetetracarboxylic acid, trimesic acid, 1,2,4,5-benzenetetracarboxylic acid and 2,4,6-triaminocaproic acid 1,3,5-triazine (TACT).

As examples of multifunctional compounds (i) bearing precursor functions of the function A and of carboxylic acid type, mention may be made especially of nitriles, primary amides, anhydrides or esters of the polyacids mentioned previously.

As examples of multifunctional compounds (i) bearing amine functions, mention may be made especially of nitrilotrialkylamines, in particular nitrilotriethylamine, dialkylenetriamines, in particular diethylenetriamine, bishexamethylenetriamine, trialkylenetetramines and tetraalkylenepentamines, the alkylene preferably being ethylene, 4-aminomethyl-1,8-octanediamine, melamine, and polyalkyleneamines, for instance the Jeffamine T® products from the company Huntsman, especially Jeffamine T403® (polyoxypropylenetriamine).

As multifunctional compounds (i) bearing precursor functions of the function B of amine type, mention may be made especially of isocyanates or carbamates of the polyamine compounds mentioned previously.

Examples of multifunctional compounds that may be suitable for use are especially cited in U.S. Pat. No. 5,346,984, U.S. Pat. No. 5,959,069, WO 96/35739 and EP 672 703.

The monofunctional compound (ii) is preferentially an aliphatic, cycloaliphatic or aromatic hydrocarbon-based compound containing between 2 and 30 carbon atoms and possibly comprising heteroatoms such as O, S, N or P.

The monofunctional compound (ii) is preferentially chosen from the group comprising: n-hexadecylamine, n-octadecylamine and n-dodecylamine, acetic acid, lauric acid, benzylamine, benzoic acid, propionic acid and 4-amino-2,2,6,6-tetramethylpiperidine.

As examples of monofunctional compounds (ii) bearing precursor functions of functions of carboxylic acid type, mention may be made especially of acetic anhydride, ethyl benzoate, methyl benzoate and hexanenitrile.

As examples of monofunctional compounds (ii) bearing precursor functions of functions of amine type, mention may be made especially of octyl isocyanate and its methyl carbamate.

The polymerization of the process of the invention is especially performed according to standard operating conditions for the polymerization of dicarboxylic acids and diamines, when this is performed in the absence of multifunctional and monofunctional compounds.

Such a polymerization process may briefly comprise:
heating, with stirring and under pressure, of the mixture of monomers and multifunctional (i) and monofunctional (ii) compounds,
maintenance of the mixture under pressure and temperature for a given time, with removal of water vapor using a suitable device, followed by decompression and maintenance for a given time at a temperature above the melting point of the mixture, especially under the autogenous pressure of the water vapor, under nitrogen or under vacuum, in order thus to continue the polymerization by removal of the water formed.

The multifunctional (i) and optionally monofunctional (ii) compounds are preferentially added at the start of the polymerization. In this case, polymerization of a mixture of dicarboxylic acid and diamine monomers and of the multifunctional (i) and monofunctional (ii) compounds is performed.

It is entirely possible to add at the start, during or at the end of polymerization common additives, for instance catalysts, especially such as phosphorus-containing catalysts, antifoams, and light or heat stabilizers.

At the end of polymerization, the polymer may be cooled advantageously with water, and extruded, and then chopped to produce granules.

The polymerization process according to the invention may entirely be performed in continuous or batch mode.

The molar percentage Tᵢ of multifunctional compounds (i) may be chosen so that the value β defined previously is less than or equal to 3.6, preferentially less than or equal to 3 and advantageously less than or equal to 2.8.

According to the invention, the modified polyamide preferentially has a solution viscosity index of between 80 and 120, according to standard ISO 307 (with 0.5% polymer dissolved in 90% formic acid, at a temperature of 25° C.), especially between 85 and 115 and more preferentially between 85 and 105.

A subject of the present invention is also a composition comprising at least the polyamide as defined previously.

Preferentially, the polyamide of the invention is used as matrix in this composition, especially for obtaining molded articles.

To improve the mechanical properties of this composition, it may be advantageous to add thereto at least one reinforcing and/or bulking filler preferentially chosen from the group comprising fibrous fillers such as glass fibers, mineral fillers such as clays, kaolin, or reinforcing nanoparticles or nanoparticles made of thermosetting material, and fillers in powder form such as talc. The level of incorporation of reinforcing and/or bulking filler is in accordance with the standards in the field of composite materials. It may be, for example, a filler content of from 1% to 80%, preferably from 10% to 70% and especially between 30% and 60%.

Besides the modified polyamide of the invention, the composition may comprise one or more other polymers, preferably polyamides or copolyamides.

The composition according to the invention may also comprise additives commonly used for the manufacture of polyamide compositions intended to be molded. Thus, mention may be made of lubricants, flame retardants, plasticizers, nucleating agents, catalysts, resilience improvers, for instance optionally grafted elastomers, light and/or heat stabilizers, antioxidants, antistatic agents, colorants, matting agents, molding additives or other conventional additives.

These fillers and additives may be added to the modified polyamide via the usual means adapted to each filler or additives, for instance during the polymerization or by cold or melt blending.

The polyamide according to the invention may also be used as matrix in a composition comprising a high proportion of additives of masterbatch type intended to be mixed with another thermoplastic composition.

The polyamide according to the invention may also be used, as additive, or as a mixture, especially for imparting certain properties, especially rheological properties, to compositions comprising as matrix a thermoplastic polymer, especially a (co)polyamide. The polyamide according to the invention is then generally mixed in molten form with thermoplastic polymers. It is especially possible to use a proportion of between 10% and 90% by weight of (co)polyamide, such as a linear (co)polyamide, especially from 30% to 80% by weight, relative to the total proportion of (co)polyamide and polyamide according to the invention.

The polyamides or compositions according to the invention may be used as raw material in the field of plastics processing, for example for preparing articles obtained by injection-molding, by injection/blow-molding, by extrusion or by extrusion/blow-molding.

According to a common embodiment, the modified polyamide is extruded in the form of rods, for example in a twin-screw extrusion device, and these rods are then chopped into granules. The molded articles are then made by melting the granules produced above and feeding the molten composition into injection-molding devices.

Specific terms are used in the description so as to facilitate the understanding of the principle of the invention. However, it should be understood that no limitation of the scope of the invention is envisioned by the use of these specific terms. The term “and/or” includes the meanings “and”, “or” and also any other possible combination of the elements connected to this term.

Other details or advantages of the invention will emerge more clearly in the light of the examples below, which are given purely as a guide.

### EXPERIMENTAL SECTION

### Example 1

### Manufacture of Polyamides

The polymerization is performed in a heated autoclave comprising stirring means and means for evacuating volatile byproducts.

92 560 g of N salt (equimolar amount of adipic acid of hexamethylenediamine), 607.9 g of bishexamethylenetriamine (0.4 mol %), 344.3 g of benzoic acid (0.4 mol %), 1504.6 g of adipic acid (1.46 mol %) and 6.4 g of antifoam are placed in an autoclave with 84 230 g of demineralized water, at a temperature of 100° C.

This stirred mixture is boiled at atmospheric pressure until an N salt concentration of 70% by weight is reached. Evacuation of the water is then stopped, and the temperature and pressure are then increased to 215° C. and 17.5 bar absolute, respectively. The mixture is maintained at this pressure for 1 hour. During this step, water is evaporated off and the temperature increased to reach 250° C. The pressure is then gradually reduced to 1 bar absolute, and the mixture is then stirred for 30 minutes while maintaining the temperature at 275° C., at 1 bar absolute.

The molten polymer is then extruded in the form of rods, and then rapidly cooled with water and chopped into granules.

Various polymers are synthesized in this manner by varying the proportion of the multifunctional, monofunctional and difunctional compounds (table 1).

Example C1 corresponds to a linear polyamide 66 manufactured at the industrial scale in the absence of multifunctional, monofunctional and difunctional compound.

### Example 2

### Manufacture of Polyamides

The polymerization is performed in a heated autoclave comprising stirring means and means for evacuating volatile byproducts.

150 g of N salt (equimolar amount of adipic acid and hexamethylenediamine), 1.231 g of bishexamethylenetriamine (0.5 mol %), 1.116 g of benzoic acid (0.8 mol %), 1.337 g of adipic acid (0.8 mol %) and 0.01 g of antifoam are placed in an autoclave with 138.5 g of demineralized water, at a temperature of 70° C.

The stirred mixture is boiled at atmospheric pressure until an N salt concentration of 70% by weight is reached. Evacuation of the water is then stopped, and the temperature and pressure are then increased to reach 225° C. and 17.5 bar absolute, respectively. The mixture is maintained at this pressure for 40 minutes.

During this step, water is evaporated off and the temperature increased to reach 250° C. The pressure is then gradually reduced to 1 bar absolute, and the mixture is then stirred for 30 minutes while maintaining the temperature at 275° C., at 1 bar absolute.

The molten polymer is then extruded in the form of rods and then rapidly cooled in water and chopped into granules.

Various polymers are synthesized in this manner by varying the proportion of the multifunctional, monofunctional and difunctional compounds (table 2, polymers 3 to 6).

Example C2 corresponds to a polymer manufactured from proportions of multifunctional compound and of monofunctional compound not satisfying the condition ΔGT>Q. This results in a polymer having a flow index equivalent to that of standard linear polyamides.

### Example 3

### Manufacture of Polyamides

The polymerization is performed in a heated autoclave comprising stirring means and means for evacuating volatile byproducts.

150 g of N salt (equimolar amount of adipic acid and hexamethylenediamine), 0.986 g of bishexamethylenetriamine (0.4 mol %), 0.559 g of benzoic acid (0.4 mol %), 1.059 g of hexamethylenediamine (0.8 mol %) and 0.01 g of antifoam are placed in an autoclave with 138.5 g of demineralized water, at a temperature of 70° C.

The stirred mixture is boiled at atmospheric pressure until an N salt concentration of 70% by weight is reached. Evacuation of the water is then stopped, and the temperature and pressure are then increased to reach 225° C. and 17.5 bar absolute, respectively. The mixture is maintained at this pressure for 40 minutes. During this step, water is evaporated off and the temperature increased to reach 250° C. The pressure is then gradually reduced to 1 bar absolute, and the mixture is then stirred for 30 minutes while maintaining the temperature at 275° C., at 1 bar absolute.

The molten polymer is then extruded in the form of rods and then rapidly cooled in water and chopped into granules (table 2, polymer 7).

### Example 4

### Properties of the Polyamides

The rheological and mechanical properties and characteristics of these polymers are collated in tables 1 and 2 below. To measure certain properties, specimens made by injection-molding are manufactured.

TABLE 1

| Polymers | C1 | 1 | 2 |
|---|---|---|---|
| Content of | 0 | 0.4 | 0.1 |
| bishexamethylenetriamine | | | |
| trifunctional compound (mol %) | | | |
| Content of benzoic acid | 0 | 0.4 | 0.5 |
| monofunctional compound | | | |
| (mol %) | | | |
| Content of adipic acid | 0 | 1.46 | 0.4 |
| difunctional compound | | | |
| (mol %) | | | |
| NH2 | 46 | 17 | 27 |
| (meq/kg) | | | |
| COOH | 73 | 202 | 122 |
| (meq/kg) | | | |
| ΔGT | 27 | 185 | 95 |
| (meq/kg) | | | |
| Q | 85 | 97 | 0 |
| (meq/kg) | | | |
| IV (1) | 143 | 87 | 97 |
| (mL/g) | | | |
| Melt flow index (2) (g/10 min) | 5 | 39 | 31 |
| Notched Charpy impact | 4.9 | 2.1 | 3.0 |
| (kJ/m²) | | | |
| Tensile strength | 61 | 66 | 73 |
| (N/mm²) | | | |
| Elongation | 30 | 1.7 | 2 |
| (%) | | | |
| Tensile modulus | 3020 | 4245 | 3985 |
| (N/mm²) | | | |

(1) Viscosity index measured using a 0.5% solution of polymer dissolved in 90% formic acid, according to standard ISO 307
(2) Melt flow index (MFI) determined according to standard ASTM D1238, measured in g/10 min at 275° C. under a 325 g load.

TABLE 2

| Polymers | C2 | 3 | 4 | 5 | 6 | 7 |
|---|---|---|---|---|---|---|
| Content of bishexa- | 0.4 | 0.5 | 0.4 | 0.4 | 0.1 | 0.4 |
| methylenetriamine | | | | | | |
| trifunctional | | | | | | |
| compound (mol %) | | | | | | |
| Content of benzoic | 0.4 | 0.8 | 0.4 | 0.4 | 0.4 | 0.4 |
| acid monofunctional | | | | | | |
| compound (mol %) | | | | | | |
| Content of | 0.6 | 0.8 | 1.2 | 0.9 | 0.15 | 0.8 |
| difunctional | | | | | | |
| compound (mol %) | | | | | | |
| NH2 | 29 | 24 | 16 | 22 | 27 | 140 |
| (meq/kg) | | | | | | |
| COOH | 122 | 152 | 199 | 156 | 119 | 40 |
| (meq/kg) | | | | | | |
| ΔGT | 93 | 128 | 183 | 134 | 92 | 100 |
| (meq/kg) | | | | | | |
| Q | 97 | 66 | 97 | 97 | 40 | 97 |
| (meq/kg) | | | | | | |
| IV (1) | 134 | 102 | 86 | 109 | 103 | 105 |
| (mL/g) | | | | | | |
| Melt flow index (2) | 5 | 21 | 44 | 15 | 20 | 17 |
| (g/10 min) | | | | | | |

(1) Viscosity index measured using a 0.5% solution of polymer dissolved in 90% formic acid, according to standard ISO 307
(2) Melt flow index (MFI) determined according to standard ASTM D1238, measured in g/10 min at 275° C. under a 325 g load.
The contents of acid and amine end groups are assayed by potentiometry, the notched Charpy impact is measured according to standard ISO 179-1/1eA at a temperature of 23° C., and the tensile strength, the elongation and the tensile modulus are measured according to standard ISO 527 at a temperature of 23° C.

### Example 5

### Charged Compositions

Compositions comprising as polyamide matrix the polyamides manufactured previously are filled with 50% by weight of glass fibers and less than 1.5% by weight of other additives (EBS wax and nigrosin sold under the name 54/1033 by the company Ferroplast) by melt blending in a Werner & Pfleiderer ZSK 40 twin-screw extruder with degassing (L/D=36). The glass fibers are Vetrotex 995. The extrusion parameters are as follows: extrusion temperature with an increasing profile 250-280° C.; screw spin speed: 250 rpm; flow rate of the composition 40 kg/h; the motor torque and the absorbed motor power vary depending on the polyamide.

The properties of the charged compositions are collated in table 3 below. To measure some of the properties, specimens made by injection molding are manufactured.

TABLE 3

| Polymer | C1 | 1 | 2 |
|---|---|---|---|
| Non-notched Charpy impact | 103 | 88.5 | 100.5 |
| (kJ/m²) | | | |
| Tensile force | 230 | 248 | 246 |
| (N/mm²) | | | |
| Elongation | 2.9 | 2.3 | 2.6 |
| (%) | | | |
| Tensile modulus | 16 100 | 16 490 | 16 250 |
| (N/mm²) | | | |
| Spiral test | 18 | 37 | 27 |
| (cm) | | | |
| Surface aspect | Poor | Good | Good |
| Motor torque | 50-55 | 40-45 | 40-45 |
| (N/mm) | | | |
| Absorbed motor power | 27 | 21 | 21 |
| (A) | | | |

The non-notched Charpy impact is measured according to standard ISO 179-1/1eU at a temperature of 23° C., and the tensile force, the elongation and the tensile modulus are measured according to standard ISO 527 at a temperature of 23° C.

The surface aspect is assessed visually on plates 100×60×3 mm in size, at least one of the faces of which is smooth. It is considered as poor when the fibers are apparent at the surface, accompanied by nonuniform whitening of the surface. It is considered as good when the surface is smooth and uniformly black.

The spiral test allows quantification of the flow index of the compositions by melting the granules and injecting them into a spiral-shaped mold of semicircular cross section 2 mm thick and 4 cm in diameter, in a BM-Biraghi 85T press at a sheath temperature of 280° C., a mold temperature of 80° C. and with an injection pressure of 80 bar (the result is expressed as the length of mold correctly filled by the composition).

1-18. (canceled)

19. A modified polyamide comprising the polymerizate of at least:
dicarboxylic acid monomers of the type AA and diamine monomers of the type BB, or salts thereof;
at least one multifunctional compound (i) which comprises either at least 3 functions A or at least 3 functions B;
optionally, at least one monofunctional compound (ii) which comprises either a function A or a function B;
such functions A and B being capable of reacting together to form an amide bond; and
said modified polyamide comprising:
from 0.02 mol % to 0.6 mol %, relative to the number of moles of constituent monomers of the polyamide, of a structural unit corresponding to the multifunctional compound (i);
optionally, up to 2 mol %, relative to the number of moles of constituent monomers of the polyamide, of a structural unit corresponding to the monofunctional compound (ii);
the resultant polyamide having a difference in absolute value ΔGT between its end groups that is greater than or equal to the value Q (limit ΔGT); this value Q being defined by the relationship:
Q=α.[(β−Tᵢᵢ)²−γ]^{0.5},
if the amount between the square brackets (β−Tᵢᵢ)²−γ is positive; or
Q=0,
if the amount between the square brackets (β−Tᵢᵢ)²−γ is negative or zero;
wherein:
α=72,
β=0.625.(f−2)³.Tᵢ²+(f−2).Tᵢ+2,
γ=2.6,
Tᵢ corresponds to the molar percentage of multifunctional compound (i),
Tᵢᵢ corresponds to the molar percentage of monofunctional compound (ii)
f corresponds to the functionality of the multifunctional compound (i) and thus corresponds to the number of functions A or B borne by the multifunctional compound (i), and
the amounts ΔGT and Q are expressed in meq/kg.

20. The modified polyamide as defined by claim 19, wherein, when the at least one multifunctional compound (i) bears functions of type A, then at least one monofunctional compound (ii) is present that bears a function of type B; and, when the at least one multifunctional compound (i) bears functions of type B, then the at least one monofunctional compound (ii) bears a function of type A.

21. The modified polyamide as defined by claim 19, wherein the dicarboxylic acid monomers comprise aliphatic or aromatic compounds containing from 4 to 12 carbon atoms selected from the group consisting of adipic acid, terephthalic acid, isophthalic acid, pimelic acid, suberic acid, decanedioic acid and dodecanedioic acid.

22. The modified polyamide as defined by claim 19, wherein the diamine monomers comprise aliphatic, optionally cycloaliphatic, or aromatic compound containing from 4 to 12 carbon atoms selected from the group consisting of hexamethylenediamine, butanediamine, m-xylylenediamine, isophoronediamine, 3,3′,5-trimethylhexamethylenediamine and methylpentamethylenediamine.

23. The modified polyamide as defined by claim 19, wherein the polyamide monomers comprise adipic acid, hexamethylenediamine and/or hexamethylenediammonium adipate.

24. The modified polyamide as defined by claim 19, further comprising the polymerizate of an amino acid or a lactam.

25. The modified polyamide as defined by claim 19, wherein the at least one multifunctional compound (i) comprises an aliphatic, cycloaliphatic and/or aromatic hydrocarbon-based compound containing from 1 to 100 carbon atoms, and optionally comprising one or more heteroatoms.

26. The modified polyamide as defined by claim 19, wherein the at least one multifunctional compound (i) is selected from the group consisting of 2,2,6,6-tetrakis(β-carboxyethyl)cyclohexanone, diaminopropane-N,N,N′,N′-tetraacetic acid, 3,5,3′,5′-biphenyltetracarboxylic acid, acids derived from phthalocyanin and naphthalocyanin, 3,5,3′,5′-biphenyltetracarboxylic acid, 1,3,5,7-naphthalenetetracarboxylic acid, 2,4,6-pyridinetricarboxylic acid, 3,5,3′,5′-bipyridyltetracarboxylic acid, 3,5,3′,5′-benzophenonetetracarboxylic acid, 1,3,6,8-acridinetetracarboxylic acid, trimesic acid, 1,2,4,5-benzenetetracarboxylic acid and 2,4,6-triaminocaproic acid 1,3,5-triazine (TACT).

27. The modified polyamide as defined by claim 19, wherein the at least one multifunctional compound (i) is selected from the group consisting of nitrilotrialkylamines, nitrilotriethylamine, dialkylenetriamines, diethylenetriamine, bishexamethylenetriamine, trialkylenetetramines, tetraalkylenepentamines, 4-aminomethyl-1,8-octanediamine, melamine, and polyalkyleneamines.

28. The modified polyamide as defined by claim 20, wherein the at least one monofunctional compound (ii) comprises an aliphatic, cycloaliphatic or aromatic hydrocarbon-based compound having from 2 to 30 carbon atoms, and optionally containing heteroatoms.

29. The modified polyamide as defined by claim 20, wherein the at least one monofunctional compound (ii) is selected from the group consisting of n-hexadecylamine, n-octadecylamine, n-dodecylamine, acetic acid, lauric acid, benzylamine, benzoic acid, propionic acid and 4-amino-2,2,6,6-tetramethylpiperidine.

30. The modified polyamide as defined by claim 19, wherein the molar percentage Tᵢ of multifunctional compounds (i) introduced is such that the value of β is less than or equal to 3.6.

31. The modified polyamide as defined by claim 19, having a solution viscosity index ranging from 80 to 120, according to standard ISO 307 with 0.5% of polymer dissolved in 90% formic acid, at a temperature of 25° C.

32. A polymerization process for the production of a modified polyamide as defined by claim 19, wherein a mixture comprising at least dicarboxylic acid and diamine monomers, or salts thereof, and the multifunctional (i) and monofunctional (ii) compounds is polymerized.

33. A polyamide molding composition comprising at least one modified polyamide as defined by claim 19, and, optionally, reinforcing and/or bulking fillers, one or more other polymers and/or additives thereof.

34. A process for the production of a molding composition as defined by claim 33, wherein a polyamide is cold- or melt-blended with reinforcing and/or bulking fillers, one or more other polymers and/or additives thereof.

35. A shaped article produced by injection-molding, by injection/blow-molding, by extrusion or by extrusion/blow-molding of the molding composition as defined by claim 33.

36. A molded or extruded shaped article comprising at least one modified polyamide as defined by claim 19.

37. The molded or extruded shaped article as defined by claim 36, having enhanced mechanical strength and a clean and uniform surface.
